(19) United States
(12) Patent Application Publication
(10) Pub. No.: US 2008/0219460 A1
(43) Pub. Date: Sep. 11, 2008

(54) Bug detector

(76) Inventor: Dennis Huang, Taipei (TW)

Correspondence Address: BACON & THOMAS, PLLC, 625 SLATERS LANE, FOURTH FLOOR, ALEXANDRIA, VA, 22314-1176, US

(21) Appl. No.: 11/878,962

(22) Filed: Jul. 30, 2007

(30) Foreign Application Priority Data
Mar. 8, 2007 (TW) 096108041

(51) Int. Cl. H04R 29/00

(52) U.S. Cl. 381/58

(57) ABSTRACT

This present invention provides a bug detector for detecting a hidden bug, comprising: an acoustic generator, an identification decoder, and a control device. The acoustic generator generates a specific audio signal for the microphone of the bug receiving the specific audio signal and outputting a radio signal through the radio transmitter. The identification decoder receives the radio signal for decoding so as to obtain a decoded audio signal. The control device connects to the acoustic generator and the identification decoder for comparing the specific audio signal with the decoded audio signal so as to determine that the bug is existence or not.

### BACKGROUND OF THE INVENTION

1. Field of the Invention

This invention relates to a bug detector and, more particularly, to a bug detector for correctly determining whether a bug is existence or not.

2. Description of Related Art

A bug usually was hidden in a room for stealing some confidential information in some espionage activity. The bug can receive an audio signal to perform modulation with a carrier wave for converting the audio signal in a radio frequency signal form. Therefore, a receiver locating at somewhere receives the radio frequency signal.

Generally, the bug is in small size to be easily hidden. Hence, it is obviously impracticable to detect the location of the bug by actually searching. FIG. 1 illustrates a schematic view of a conventional bug detector. Referring to FIG. 1, the audio receiver 1 as a bug detector can search a radio frequency signal outputted by the bug 2 for determining whether the bug 2 is existence or not. The abovementioned method needs someone to generate some sound so as to drive the bug 2 to output the radio frequency signal; however, which is very inconvenient for the users. In addition, the audio receiver 1 may receive some wireless waves such as other radio frequency waves or undesired sound or noise. Therefore, the audio receiver 1 can not correctly determine whether the bug is existence or not. Therefore, it is desirable to provide a bug detector to mitigate and/or obviate the aforementioned problems.

### SUMMARY OF THE INVENTION

This present invention provides a bug detector for detecting a hidden bug, comprising: an acoustic generator generating a specific audio signal for a microphone of the bug receiving the specific audio signal and a radio transmitter outputting a corresponding radio signal; an identification decoder receiving the radio signal for decoding so as to obtain a decoded audio signal; and a control device connecting respectively to the acoustic generator and the identification decoder for controlling the acoustic generator to generating the specific audio signal, and determining that if the specific audio signal corresponds to the decoded audio signal generated by the identification decoder so as to determine that the bug is existence or not.

The control device comprises a display and switch input unit comprising a plurality of switches for setting different on/off status for controlling the operation mode of the bug detector and a plurality of light emitting diodes with different display status capable of displaying different operation status of the bug detector, and a central processor coupled to the acoustic generator, the display and switch input unit, and the identification decoder for providing the functions of controlling the audio outputting, display and input switching, and receiving and data inputting.

The central processor operates the switches to generate an audio encoding signal to be transmitted to the acoustic generator, a volume control signal to be transmitted to the acoustic generator, and a frequency switching signal to be transmitted to the identification decoder.

The acoustic generator comprises an audio signal generator, an audio amplifier, and a speaker. The audio signal generator connects to the central processor for receiving the audio encoding signal so as to generate the specific audio signal; the audio amplifier connects to the audio signal generator and the central processor respectively, comprising a gain controller for receiving the volume control signal to amplify the specific audio signal generated by the audio signal generator; the speaker electrically connects to the audio amplifier for outputting a audio corresponding to the specific audio signal.

The identification decoder comprises a broadband wireless receiver, and an audio decoder. The broadband wireless receiver connects to the central processor for receiving the frequency switching signal to switch at least one receiving frequency for receiving the radio signal; the audio decoder connects to the broadband wireless receiver and the central processor respectively for receiving the radio signal to decode so as to obtain the decoded audio signal and transmit the decoded audio signal to the central processor.

The central processor determines that whether the decoded audio signal is corresponding to the audio encoding signal or not; if true, then the central processor controls active quantity or brightness of the light emitting diodes according to the intensity of the radio signal.

Therefore, compared with those in the prior art, this present invention provides a bug detector with a further means for identifying a specific audio signal. The user only needs to use the acoustic generator to generate the specific audio signal rather than making some sound. The bug will generate a corresponding radio signal after receiving the specific audio signal. Then, the identification decoder receives the radio signal for decoding so as to generate a decoded audio signal. Finally, the control device compares the specific audio signal with the decoded audio signal to determine if the decoded audio signal corresponds to the specific audio signal so as to prevent from determining wrong due to ordinary noise. Therefore, the accuracy of the determination of the bug existence is improved.

Other objects, advantages, and novel features of the invention will become more apparent from the following detailed description when taken in conjunction with the accompanying drawings.

### BRIEF DESCRIPTION OF THE DRAWINGS

FIG. 1 illustrates a schematic view of conventional bug detector.

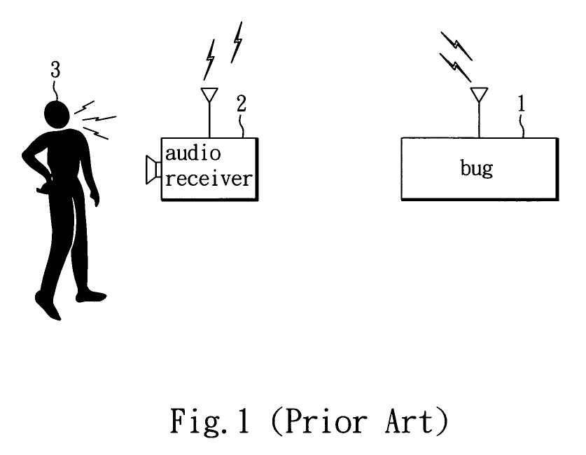

FIG. 2 shows a schematic view illustrating a bug detector according to a preferred embodiment of the present invention.

FIG. 3 shows a diagram illustrating a control device according to a preferred embodiment of the present invention.

FIG. 4 shows a diagram illustrating an acoustic generator according to a preferred embodiment of the present invention.

FIG. 5 shows a diagram illustrating an identification decoder according to a preferred embodiment of the present invention.

### DETAILED DESCRIPTION OF THE PREFERRED EMBODIMENT

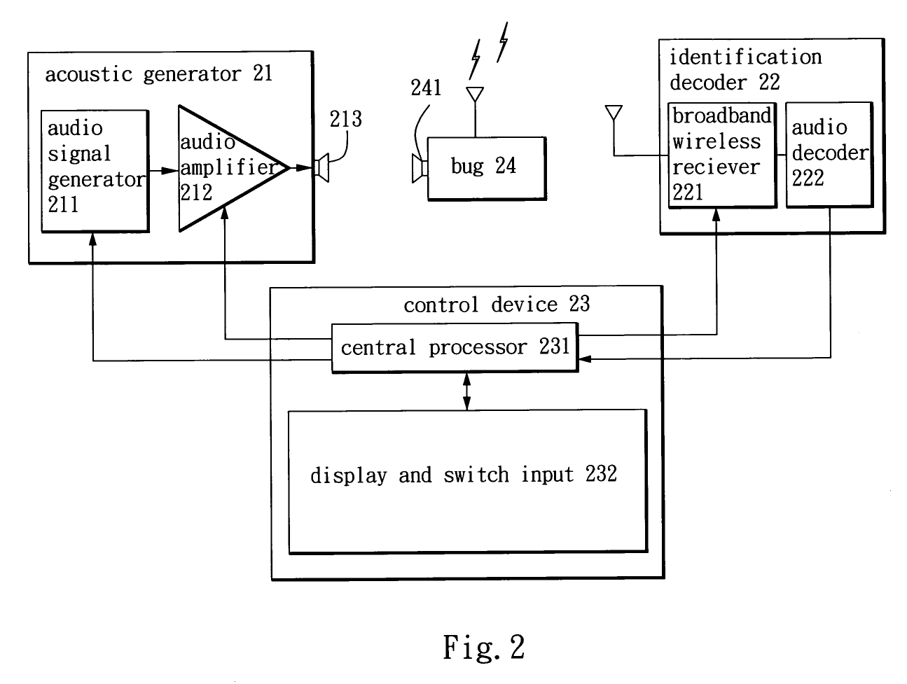

FIG. 2 shows a schematic view illustrating a bug detector according to a preferred embodiment of the present invention.

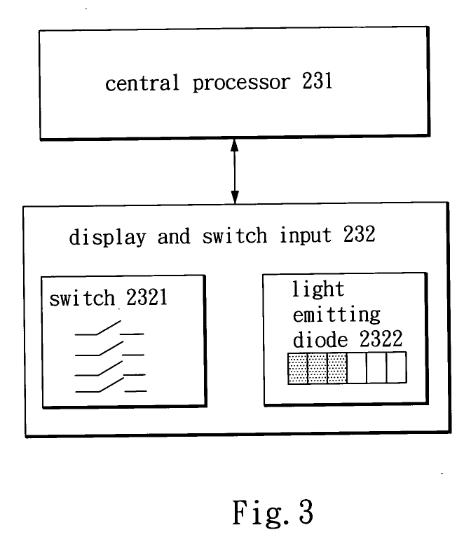

As shown in FIG. 2, the present invention provides a bug detector for detecting a hidden bug 24 comprising an acoustic generator 21, a identification decoder 22, and a control device 23. The acoustic generator 21 generates a specific audio signal, received by the microphone 241 of the bug 24, and then a radio transmitter (not shown) will output a corresponding radio signal to the specific audio signal. The identification decoder 22 receives the radio signal for decoding so as to generate a decoded audio signal. The control device 23 connects to the acoustic generator 21 and the identification decoder 22 respectively for controlling the acoustic generator 21 to generate the specific audio signal, and determining that if the decoded audio signal generated by the identification decoder 22 is corresponding to the specific audio signal so as to determine if the bug 24 is existence or not. The control device 23 comprises a central processor 231, and a display and switch input unit 232. The central processor 231 couples to the acoustic generator 21, the display and switch input unit 232 and the identification decoder 22 respectively for providing the functions of controlling the audio outputting, display and input switching, and receiving and data inputting. As shown in FIG. 3, the display and switch input unit 232 comprises a plurality of switches 2321 and a plurality of light emitting diodes 2322. The switches 2321 are provided setting different on/off status for the central processor 231 to read and then the central processor 231 controls the operation mode of the bug detector. The light emitting diodes 2322 are provided for displaying different display status capable of displaying different operation status of the bug detector. Therefore, the central processor 231 can transmit an audio encoding signal to the acoustic generator 21 according to the different status set by the switches 2321 for determining the frequency of the specific audio signal, a volume control signal to the acoustic generator 21 for controlling the volume of the specific audio signal, and a frequency switching signal to the identification decoder 22 for switching the receiving frequency, wherein all of the audio encoding signal, the volume control signal, and the frequency switching signal are 4-bit signals.

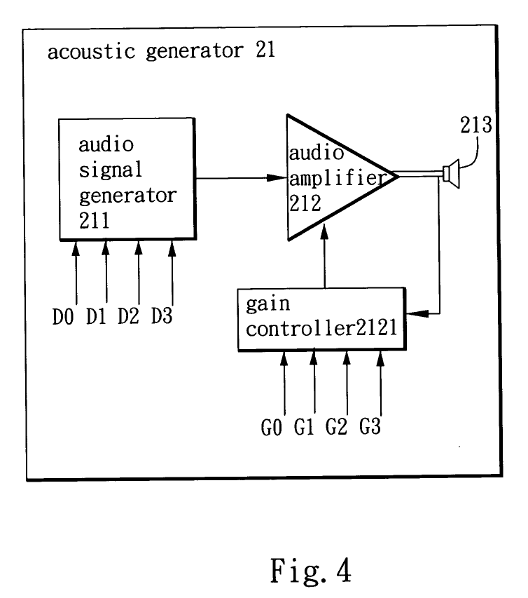

Referring to FIG. 4, which shows the block diagram of the acoustic generator 21 according to the present invention. The acoustic generator 21 comprises an audio signal generator 211, an audio amplifier 212, and a speaker 213. The audio signal generator 211 connects to the central processor 231 through the pins D0, D1, D2, and D3 for receiving the audio encoding signal so as to generate the specific audio signal according to the audio encoding signal. The audio amplifier 212 comprises a gain controller 2121 for controlling the amplified multiple value. The gain controller 2121 has the pins G0, G1, G2, and G3 receiving the volume control signal transmitted by the central processor 231 for controlling the amplified multiple value. The audio amplifier 212 connects to the audio signal generator 211 for amplifying the received specific sound signal. The speaker 213 electrically connects to the audio amplifier 212 for outputting a corresponding audio according to the amplified specific audio signal as mentioned above.

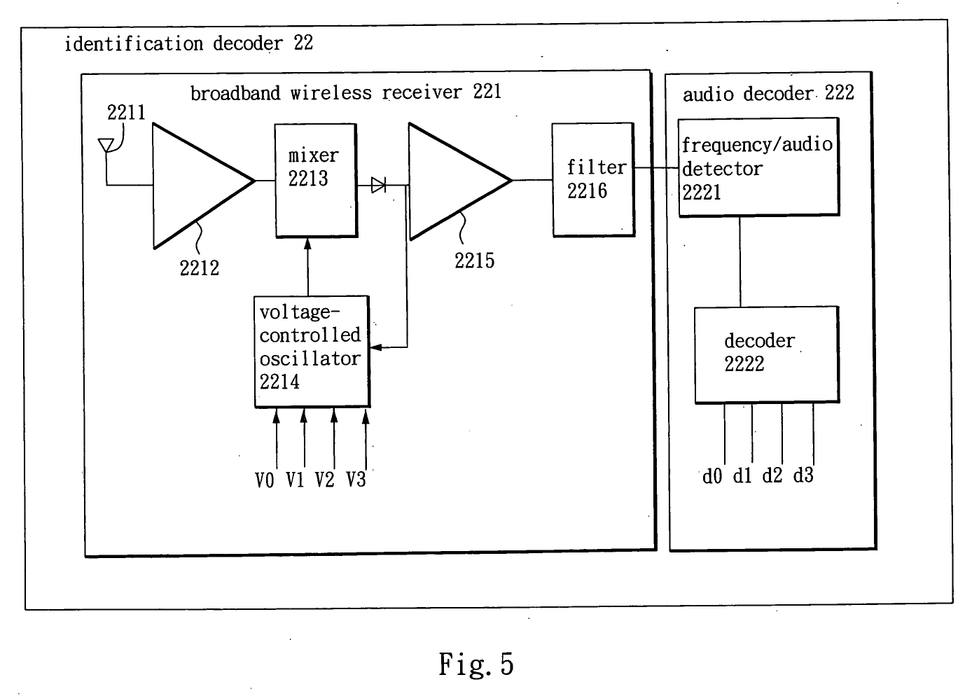

As shown in FIG. 5, which shows the circuit scheme of the identification decoder 22 of the present invention, the identification decoder 22 comprises a broadband wireless receiver 221 and an audio decoder 222.

The above-mentioned broadband wireless receiver 221 connects to the central processor 231 and the audio decoder 222 respectively. The broadband wireless receiver 221 comprises an antenna 2211, a low noise amplifier 2212 connected to the antenna 2211, a mixer 2213 connected to the low noise amplifier 2212, a voltage-controlled oscillator 2214 connected to the mixer 2213, a middle-frequency amplifier 2215 connected to the mixer 2213, and a filter 2216 connected to the middle-frequency amplifier 2215 and the audio decoder 222 respectively. The voltage-controlled oscillator 2214 has four pins V0, V1, V2, and V3 for receiving the frequency switching signal transmitted by the central processor 231 to generate at least one local oscillating frequency according to the frequency switching signal. The mixer 2213 descends the frequency of the radio signal to at least one middle-frequency signal with the at least one local oscillating frequency. Therefore, as mentioned above, the broadband wireless receiver 221 scans the radio signal according to the frequency switching signal. The radio signal is received with the antenna 2211, amplified and transmitted to the mixer 2213 with the low noise amplifier 2212. The mixer 2213 receives at least one local oscillating frequency sent out by the voltage-controlled oscillator 2214 for converting the radio signal to a middle-frequency signal. The middle-frequency amplifier 2215 amplified the mid-frequency signal, and then the filter 2216 will filter out noise of the middle-frequency signal so as to transmit to the audio decoder 222.

The audio decoder 222 comprises a frequency/audio detector 2221 and a decoder 2222, wherein the frequency/audio detector 2221 connects to the filter 2216 and the decoder 2222 respectively. The decoder 2222 connects to the central processor 231 through the pins d0, d1, d2, and d3. The frequency/audio detector 2221 receives the descended middle-frequency radio signal for performing demodulation so as to generate an audio signal. After that, the audio signal is transmitted to the decoder 2222 for decoding and then obtaining a 4-bit decoded audio signal. The frequency/audio detector 2221 transmits the 4-bit decoded audio signal to the central processor 231 through the pins d0, d1, d2, and d3. The central processor 231 determines that whether the 4-bit decoded audio signal is corresponding to the audio encoding signal or not; if true, then the central processor 231 can determine that the generated specific audio signal indeed received by a bug and the bug sends out a corresponding radio signal. Therefore, the existence of the bug is confirmed. Further, the central processor 231 also can control active quantity or brightness of the plurality of light emitting diodes 2322 according to the received intensity of the radio signal.

When using, user can operate the plurality of switches 2321 first for driving the central processor 231 to generate an audio encoding signal to transmit to the audio signal generator 211 for generating the specific audio signal. And then, amplifying the volume control signal transmitted to the audio amplifier 212 for amplifying the specific audio signal. After that, enabling the speaker 213 to send out voice continuously to detect in a broad range.

If a hidden bug 24 indeed exists in somewhere, the identification decoder 22 can obtain the specific audio signal and the control device 23 can control the lighting of the light emitting diodes 2322 to indicate the existence of the bug 24. For identifying the real location of the bug 24, the user can lower the volume control signal for decreasing the intensity of the radio signal and move the bug detector. While the intensity of the radio signal becomes strong again, the user can lower the volume control signal for decreasing the strength the radio signal and move the bug detector again. After repeating the above-mentioned step, the position of the bug 24 can be allocated by the bug detector.

From the above-mentioned, this present invention provides a bug detector with a means for identifying a specific audio signal. The user only needs to use the acoustic generator to generate a specific audio signal without make any sound, and the bug will generate a radio signal after receiving the specific audio signal. The identification decoder receives the radio signal for decoding so as to generate a decoded audio signal. Thus, the control device compares the specific audio signal with the decoded audio signal to check if the decoded audio signal is corresponding to the specific audio signal so as to determine the bug is existence or not.

Although the present invention has been explained in relation to its preferred embodiment, it is to be understood that many other possible modifications and variations can be made without departing from the scope of the invention as hereinafter claimed.

What is claimed is:

1. A bug detector for detecting a hidden bug, comprising:
an acoustic generator, generating a specific audio signal for a microphone of the bug receiving the specific audio signal and a radio transmitter of the bug outputting a corresponding radio signal;
an identification decoder, receiving the radio signal for decoding so as to obtain a decoded audio signal; and
a control device, connecting respectively to the acoustic generator and the identification decoder for controlling the acoustic generator to generating the specific audio signal, and determining that if the specific audio signal corresponds to the decoded audio signal generated by the identification decoder so as to determine that the bug is existence or not.

2. The bug detector as claimed in claim 1, wherein the control device comprising:
a display and switch input unit, comprising a plurality of switches for setting different on/off status for controlling the operation mode of the bug detector and a plurality of light emitting diodes with different display status capable of displaying different operation status of the bug detector; and
a central processor, coupled to the acoustic generator, the display and switch input unit, and the identification decoder for providing the functions of controlling the audio outputting, display and input switching, and receiving and data inputting.

3. The bug detector as claimed in claim 2, wherein the central processor operates the switches to generate an audio encoding signal to be transmitted to the acoustic generator, a volume control signal to be transmitted to the acoustic generator, and a frequency switching signal to be transmitted to the identification decoder.

4. The bug detector as claimed in claim 2, wherein the acoustic generator comprises an audio signal generator, an audio amplifier, and a speaker.

5. The bug detector as claimed in claim 4, wherein the audio signal generator connects to the central processor for receiving the audio encoding signal so as to generate the specific audio signal; the audio amplifier connects to the audio signal generator and the central processor respectively, comprising a gain controller for receiving the volume control signal to amplify the specific audio signal generated by the audio signal generator; the speaker electrically connects to the audio amplifier for outputting a audio corresponding to the specific audio signal.

6. The bug detector as claimed in claim 5, wherein the identification decoder comprises a broadband wireless receiver, and an audio decoder.

7. The bug detector as claimed in claim 6, wherein the broadband wireless receiver connects to the central processor for receiving the frequency switching signal to switch at least one receiving frequency for receiving the radio signal; the audio decoder connects to the broadband wireless receiver and the central processor respectively for receiving the radio signal to decode so as to obtain the decoded audio signal and transmit the decoded audio signal to the central processor.

8. The bug detector as claimed in claim 2, wherein the central processor determines that whether the decoded audio signal is corresponding to the audio encoding signal or not; if true, then the central processor controls active quantity or brightness of the light emitting diodes according to the intensity of the radio signal.
